(19) United States
(12) Patent Application Publication
(10) Pub. No.: US 2010/0011562 A1
(43) Pub. Date: Jan. 21, 2010

(54) NON-WOVEN WITH SELECTED LOCATIONS/REGIONS OF JOINED FIBERS FOR MECHANICAL ATTACHMENT

(75) Inventors: Kate CAULEY, Marlborough, MA (US); Eberhard Link, Raleigh, NC (US); Eva WELSH, Durham, NC (US)

Correspondence Address: GROSSMAN, TUCKER, PERREAULT & PFLEGER, PLLC, 55 SOUTH COMMERICAL STREET, MANCHESTER, NH, 03101, US

(73) Assignee: FREUDENBERG NONWOVENS, L.P., Durham, NC (US)

(21) Appl. No.: 12/505,108

(22) Filed: Jul. 17, 2009

Related U.S. Application Data
(60) Provisional application No. 61/081,591, filed on Jul. 17, 2008.

(51) Int. Cl. B23P 19/02; B32B 3/06

(52) U.S. Cl. 29/525; 428/99

(57) ABSTRACT

In a first embodiment, the present disclosure is directed at a non-woven fabric, which provides, at selected locations, the ability to mechanically and releasably join with a hook fastener. The non-woven web may include entangled fibers which have been overprinted with dots, lines or designs to create defined locations of joined fibers which may engage with a corresponding hook profile. The print material may include thermoplastic and thermoset binder systems. The binder systems may include a gas expanding substrate (e.g. gas-filled microspheres) which may provide a relatively thicker location for joining with the corresponding hook engaging material.

### CROSS REFERENCE TO RELATED APPLICATIONS

This application claims the benefit of U.S. Provisional Application No. 61/081,591, filed Jul. 17, 2008, the teachings of which are incorporated by reference.

### FIELD

The present disclosure relates to a non-woven fabric which may be configured, at selected locations, to provide mechanical attachment points for a hook fastener. The non-woven may therefore serve as a disposable attachment pad for a given consumer application.

### BACKGROUND

“Hook and loop fasteners”, which may easily and quickly permit the fastening of various generally flat materials, are increasingly used today. Both the fastening of edges adjoining one another, as well as use as fastener straps covering only a portion of the surface of the objects to be joined may be possible. The hook and loop fasteners may be generally made of two components, the hook part made of extruded single-hooked, double-hooked or mushroom-shaped protrusions, and an interlocking entanglement part having a loop-like arrangement of fibers or threads for the hook portion to penetrate and engage. Differentiation may generally be made between hook and loop fasteners that are used repeatedly, for example, on shoes which must undergo a great number of closings and openings during their useful life, and single or infrequent use hook and loop fasteners which are only closed and opened a few times, e.g., on disposable or replaceable products. Such disposable products may be, for example, hook and loop fasteners on hygiene products such as children's diapers or incontinence products for adults.

The loop fastener member may have loop or arch-shaped engaging elements protruding from one surface of a base fabric which may comprise all or a portion of the surface of a first object to be joined, and the hook fastener member may have hook or mushroom-shaped engaging elements protruding from one surface of a second object to be joined. By pressing both of the engaging elements together, the loop and hook fastener members may engage one another, forming a temporary mechanical bond, thereby firmly fastening the objects together. Since each of the objects carry either the hook or the loop fastener member, the objects may be separated, for instance, to exchange one of the objects which may have become soiled or worn out. With such easy fastening and separating performance, this type of surface fastener has been widely used as a fastener for opening and closing clothes, shoes, bags, etc., as fasteners for attaching sanding discs to sanding wheels, as fasteners for the replacement of heads on mops, etc., and as fasteners for attaching sheet covers to bedding.

As alluded to above, the application field of surface fasteners has expanded to include disposable/replaceable products. In this application field, since the engaging surface area of the loop fastener member may be minimized to decrease production costs, there is an increasing need for a loop fastener member that is relatively inexpensive, reliable in terms of bonding, thin, and flexible.

### SUMMARY

In a first aspect, the present disclosure relates to a non-woven fabric suitable for use as a fastening member with a hook fastener member, comprising a web of entangled fibers having a surface, and a printed pattern of a binder material selectively located on said surface, the binder material interconnecting at least some of the fibers and creating defined spaces between the fibers such that the spaces are capable of releasable engagement with the hook fastener member.

In a second aspect, the present disclosure relates to a method of releasably joining two objects, comprising providing a portion of a non-woven fabric, including a web of entangled fibers having a first surface and a second surface, as the first object, providing a binder material and over-printing a pattern of said binder material onto at least a portion of said first surface. This may be followed by providing a hook fastener member, including a plurality of protruding elements, as the second object, pressing the first surface of the first object against the elements of the second object to engage the elements with the entangled fibers, wherein the binder material interconnects at least some of the fibers and creates defined spaces between the fibers such that the spaces are capable of releasable engagement with the hook elements.

The fabric may contain a non-woven web of entangled fibers which fiber have been, at selected locations, overprinted with dots, lines or designs to create defined spaces between the fibers which are interlocked by the printed dots/lines. Such defined spaces may therefore provide one or a plurality of engaged fibers which may then serve as an attachment location with a corresponding hook engaging portion. The print material may be a thermoplastic or thermoset (cross-linkable polymer) type binder. The binder may also include microspheres or other gas generating additive which may expand during heating to increase the height of the three dimensional pattern printed on the surface of the non-woven fabric. Such increase in height may then provide a deeper cross-section of engaged fibers for ensuing attachment purposes.

The binder may be applied in a variety of patterns on the non-woven surface. For example, the binder may be applied in the form of dots, lines or other geometric design patterns to provide defined spaces of engaged fibers which are interlocked and capable of engagement with a corresponding hook type fiber profile.

Accordingly, a non-woven fabric is provided containing selected surface locations where a hook fastener may engage the surface to provide temporary joining of two objects. In addition, the fabric may be one such that upon separation (i.e. separation of the hooks with the selected locations of the non-woven) there is not a substantial amount of fibers retained by the hooks or disrupted from the surface of the non-woven fabric upon separation of the hook member.

### DETAILED DESCRIPTION

The present disclosure stands directed to a non-woven fabric suitable for use as a fastener member that may be specifically applied to disposable products. The non-woven may be relatively thin, relatively flexible and relatively low in production cost.

Another object of the present disclosure is to provide a non-woven fabric for use as a fastener member, containing entangled fibers that have been engaged to one another at selected locations, such that the engaging locations may be formed that are relatively resistant to being pulled out from other portions of the non-woven when subjected to a pulling force by a corresponding hook engaging element. This may then provide that the hook member can be separated with reasonable force and remain relatively free of loose fibers which might interfere with multiple attachment and release cycles.

It may be appreciated that by reducing the amount of loose fibers, one may provide an attachment system that may avoid the contamination of other surrounding attachment locations, as well as remove the development of reduced quality in the actual strength of the attachment.

As may be appreciated, hooks and defined spaces for fastening, particularly for objects that may only be temporarily joined, may comprise a molded hook member including a plurality of hook or mushroom-shaped elements which may engage a non-woven fabric and provide a temporary mechanical bond for use as a temporary fastening device. As noted, the non-woven fabric may include selected regions that join the fibers such that the hooks may engage with such selected locations in the non-woven and provide useful mechanical attachment.

Such a system may be particularly suited for joining objects where one of the objects may have a limited life or durability, for instance as with sanding discs and a sanding wheel or with replacement heads for a cleaning mop, etc. More particularly, the non-woven of the present disclosure may provide a surface which may engage the hooks and remain relatively intact upon separation of the non-woven with the selected attachment locations, from the hook member. As noted above, relatively few, if any, fibers may be separated from the surface of the non-woven and relatively few, if any of the non-woven fibers, may become withdrawn by the hook elements.

The selected location on the non-woven for joining with the hooks may comprise all of the non-woven surface or may only cover selected portions of the surface. A variety of patterns may be considered, e.g. localized round or square patterns or even rectangular or triangular attachment locations. In addition, the attachment location may amount to strips running along all or a portion of the surface of the non-woven. Any sort of selected pattern for the selected locations of joined fibers which may function as “loops” for the hooks, and may correspond to match a selected pattern for the corresponding hook members.

The non-woven fabric may comprise a non-woven web of staple fibers formed by a carding process, a melt spinning process such as a spunbond process, flash spinning process or melt blowing process, or a combination thereof. The formed web may also be subjected to an entanglement process, such as by hydroentanglement, needlepunching or thermally bonding. Such mechanical, thermal or hydrodynamic entanglement may identify locations where the fibers may be joined to provide one or more location points for hook attachment.

The fibers for the non-woven may comprise any fiber suitable for preparation of a non-woven. This may therefore include polyesters, polyamides, natural fibers (e.g. cellulosics), olefin based fibers (e.g. polypropylene fibers), and/or regenerated cellulosic fibers. The non-woven may also include recycled fibers (i.e. fibers secured from post-consumer recycling facilities). The staple fibers may have a length of between about 10 mm. to about 100 mm and a denier of about 1 denier to about 15 denier. The non-woven web of entangled fibers may have a basis weight of about 80 g/m² to about 500 g/m².

As noted above, the surface of the non-woven fabric may be printed with dots or lines of a binder material, in a desired pattern. The polymeric binder material may be applied to the surface of the web of entangled fibers by electrostatic spraying, gravure coating, rotary screen printing, pad printing, roller coating, etc. Such binder material may also be dispersed as a plurality of polymer particles on to the web surface in predetermined areas, having predetermined shapes to tie individual staple fibers together, forming attached fiber locations. The polymer particles may be thermoplastic, such that upon application of heat, they flow and upon cooling, the thermoplastic polymer binder solidifies and interlocks the fibers of the non-woven material. Again, this interlocking, at selected locations on the non-woven fiber surface, will provide attachment locations for interlocking with a corresponding hook profile.

The binder material may also comprise a thermoset type (crosslinkable) polymer binder system, which may be applied in liquid or even solid form, and which may be heated to develop crosslinking. Such crosslinking will then result in solidification at selected locations on and within the non-woven, and again, provide attachment locations for a corresponding hook fastener system.

To provide an even greater three dimensional pattern of the binder (thermoplastic and/or thermoset) on the web surface, the binder may include a gas expanding substrate, such as gas-filled microspheres. The gas expanding substrate (e.g. the gas-filled microspheres) may then be configured to expand at those locations where binder (thermoplastic and/or thermoset) is applied. It may be appreciated that such expanding will result in creating a “depth” to those selected locations of the non-woven surface that are designed for attachment with the corresponding hook profiles. This additional “thickness” of the pattern may further enhance the retention of the hook elements in the fibers of the non-woven fabric.

In a second exemplary embodiment, the non-woven web of entangled fibers may be embossed to provide a pattern of projections and depressions, again to create a three dimensional effect at the surface of the web and further provide greater depth for the hook portions of the fastening system for ultimate engagement. The embossment may occur through the application of heat and mechanical force (pressure) applied to disrupt the outer surface of the web in a three dimensional pattern. Such embossment may be applied by calendaring, by one or more heated rollers, by interdigitation or deep drawing. Such embossing may be performed on the outer surface of the web, causing a plurality of depressions or valleys to be formed in the surface, or the embossing may be performed on a second surface of the web such that the pattern reads through the web and is formed as projections from the original surface of the web. It is further contemplated that embossment may occur on both sides of the web, forming areas of projections and depressions in the outer surface. Generally, such deformation may occur at temperatures between the glass transition temperature (Tg) and the melt temperature (Tm) of the fibers. Such projections and depressions may generally be in the form of such shapes as cones, pyramids, cylinders, prisms, etc. to provide surface having greater loft or bulkiness.

After such embossing, the outer surface of the web may be printed with dots and lines of a binder material, as described above, to create defined spaces between the entangled fibers that may again act as attachment locations and to improve the retention of the fibers in the non-woven fabric upon separation from the hook member.

As noted above, the print and print design pattern herein, applied to a non-woven surface, may provide an opportunity to restrict available fibers to act as attachment points and to further retain the staple fibers into the web such that they are not easily separated from the web during disconnection of corresponding hook elements from the non-woven fabric surface. The present disclosure therefore is believed to be particularly applicable for situations where a hook member is reused multiple times such as with a consumer mop pad and a mop handle. In such an application, it may be important that the hook portion and attachment portion of the fastening system are now relatively easy to engage, hold firmly together during use, are relatively easy to separate with reasonable force and, upon separation, the integrity of the attachment locations on the non-woven material is sufficient to substantially prevent loose fibers from being dislodged or being retained in the hook elements.

What is claimed is:

1. A non-woven fabric suitable for use as a fastening member with a hook fastener member, comprising a web of entangled fibers having a surface, and a printed pattern of a binder material selectively located on said surface, said binder material interconnecting at least some of said fibers and creating defined spaces between said fibers such that said spaces are capable of releasable engagement with said hook fastener member.

2. The fabric of claim 1 wherein said printed pattern is in the form of dots or lines.

3. The fabric of claim 2 wherein said pattern comprises one or more of round, square, rectangular or triangular attachment locations.

4. The fabric of claim 2 wherein said pattern is configured in strips.

5. The fabric of claim 1 wherein said binder material comprises a thermoplastic or thermosetting polymer.

6. The fabric of claim 1 wherein the pattern has a height and a gas-generating additive may be included in said binder to increase said height.

7. The fabric of claim 1 wherein said surface of said web further includes a pattern of embossed projections and depressions.

8. The fabric of claim 1 wherein said fibers are staple fibers.

9. The fabric of claim 1 wherein said fibers include one or more of polyester fibers, polyamide fibers, natural fibers, olefin-based fibers, regenerated cellulosic fibers and recycled fibers.

10. The fabric of claim 8 wherein said fibers have a length in the range of between about 10 mm to about 100 mm.

11. The fabric of claim 8 wherein said fibers have a denier in the range of between about 1 to about 15 denier.

12. The fabric of claim 8 wherein said web has a basis weight in the range of about 80 to about 500 g/m².

13. A disposable attachment pad for releasably attaching to a hook fastener member, comprising a portion of a non-woven fabric including a web of entangled fibers having a surface and a printed pattern of a binder material selectively located on said surface, said binder material interconnecting at least some of said fibers and creating defined spaces between said fibers such that said spaces are capable of releasable engagement with said hook member.

14. A method of releasably joining two objects, comprising:
providing a portion of a non-woven fabric, including a web of entangled fibers having a first surface and a second surface, as the first object;
providing a binder material;
over-printing a pattern of said binder material onto at least a portion of said first surface;
providing a hook fastener member, including a plurality of protruding elements, as the second object;
pressing said first surface of said first object against said elements of said second object to engage said elements with said entangled fibers, wherein said binder material interconnects at least some of said fibers and creates defined spaces between said fibers such that said spaces are capable of releasable engagement with said hook elements.

15. The method of claim 14 wherein upon separation of said first object from said second object, substantially no fibers are retained by said hook elements or are disrupted from said first surface.

16. The method of claim 14 wherein said one or both first and second surfaces of said web are embossed with a pattern of projections and/or depressions.

17. The method of claim 16 wherein said embossed pattern may be applied by calendaring, interdigitation, heated rollers and/or deep drawing.

18. The method of claim 16 wherein said embossed pattern of projections and/or depressions may be in shape of one or more of cones, pyramids, cylinders and prisms.

19. The method of claim 14 wherein said web of fibers may be entangled by mechanical, thermal or hydrodynamic means.

20. The method of claim 14 wherein said binder may be applied by electrostatic spraying, gravure coating, rotary screen printing, pad printing and roller coating.

21. The method of claim 14 wherein said printed pattern is in the form of dots or lines.

22. The method of claim 14 wherein said printed pattern comprises one or more of localized round, square, rectangular or triangular attachment locations.

23. The method of claim 14 wherein said pattern is configured in strips.

24. The method of claim 14 wherein said binder material comprises a thermoplastic or thermosetting polymer.

25. The method of claim 14 wherein the printed pattern has a height and a gas generating additive may be included in said binder to increase said height.

26. The method of claim 14 wherein said fibers are staple fibers.

27. The method of claim 14 wherein said fibers include one or more of include polyester fibers, polyamide fibers, natural fibers, olefin-based fibers, regenerated cellulosic fibers and recycled fibers.

28. The method of claim 26 wherein said fibers have a length in the range of between about 10 mm to about 100 mm.

29. The method of claim 26 wherein said fibers have a denier in the range of between about 1 to about 15 denier.

30. The method of claim 26 wherein said web has a basis weight in the range of about 80 to about 500 g/m².

31. The method of claim 26 wherein said staple fibers are formed into said web by one or more of a carding process, a spunbond process, a flash spinning process or a melt blowing process.
